(19) United States
(12) Patent Application Publication
(10) Pub. No.: US 2007/0147034 A1
(43) Pub. Date: Jun. 28, 2007

(54) Transparent Plate with Color-Changeable Lighting Image

(76) Inventor: Xuliang Li, Dongguan (CN)

Correspondence Address: GLOBAL IP SERVICES, 2462 ROCK ST., APT. 6, MOUNTAIN VIEW, CA, 94043, US

(21) Appl. No.: 11/306,439

(22) Filed: Dec. 28, 2005

(51) Int. Cl. F21V 9/00

(52) U.S. Cl. 362/231

(57) ABSTRACT

The transparent plate with color-changeable lighting image comprises a transparent plate, a color-changeable light source, and an attachment. Said transparent plate is covered by a white or color image layer on its surface, said color-changeable light source is disposed on one side of the transparent plate along a direction normal to the section of the side thereof, and said transparent plate and color-changeable light source are fastened together by the attachment means. The invention has no need to replace the changeable light source and may have various patterns and art words screen-printed therein, thus producing a full color flashing and fadeless effect.

### FIELD OF THE INVENTION

The present invention relates to a decorative lighting device, and more particularly to a transparent plate with color-changeable lighting image, which has simple structure and beautiful decoration effect.

### BACKGROUND OF THE INVENTION

Nowadays, various plate-like decorative colorful lighting units, such as festival decorative lamps and lighting indicator boards, are employed in vast fields where decoration is needed. Commonly, people use pluralities of colorful lighting strings, and then mount them in arrays to kinds of lighting boxes to form a number of art words and patterns; in addition, colorful bulbs are used to produce decorative effect by emitting colorful light. However, it is noted from the above structure that the amount of colorful bulbs used will be great; moreover, it will take amount of time and money to rearrange these changed art words and patterns. In addition, conventional colorful bulbs produce only unchangeable color-mixing effect, but not full color-mixing effect.

### SUMMARY OF THE INVENTION

Regarding the drawbacks of conventional technology, the invention provides a transparent plate with color-changeable lighting image, which has simple structure and beautiful decorative effect. The invention has no need to replace the changeable light source and may have various patterns and art words screen-printed therein, thus producing a full color flashing and fadeless effect.

For achieving above-mentioned object, the transparent plate with color-changeable lighting image of the invention comprises a transparent plate, a color-changeable light source, and an attachment means. Said transparent plate is covered by an image layer on its surface, the image layer is a white or color layer. Said color-changeable light source is disposed on a side of the transparent plate along a direction normal to the section of the side thereof, and said transparent plate and color-changeable light source are fastened together by the attachment means.

The color-changeable light source is comprise comprises a plurality of colorful lamps; a control circuit, a control circuit board and a power supply means. All of which are coupled together as follows: several sets of colorful lamps with various shape arrangements are mounted on the control circuit board, and control circuits for controlling brightness and switching on/off of the colorful lamps are disposed on the control circuit board.

The sets of colorful lamps include LED (light-emitting diode) lamps, which can emit red, green and blue light.

The transparent plate may be constructed by glass or acryl material or other transparent materials.

The white or color image layer may comprise kinds of patterns or words and be attached onto the surface of the transparent plate by method of screen-printing.

The invention having the abovementioned structure may screen-print desirable art words and patterns on the transparent plate according desired decoration specification quickly and easily. The light beam generated by the color-changeable light source enters into the transparent plate from a section of one side of the plate. The light mirror-reflects at both interior surfaces of the transparent plate and is delivered forwardly. The light is invisible from the surfaces of the transparent plate, but diffuses at the image layer. For the white image layer, since white color reflects all kinds of colors, the white image layer will present color-mixing effect produced by full color alternation of the color-changeable light source. For the color image layer, it will present other different color-mixing effect too. Therefore, the invention takes the advantages of simple structure, low cost and good decoration effect.

The present invention will become more obvious from the following description when taken in connection with the accompanying drawings, which show, for purposes of illustration only, preferred embodiments in accordance with the present invention. In the drawings:

### BRIEF DESCRIPTION OF THE DRAWINGS

FIG. 1 illustrates an exploded perspective view of the present invention.

FIG. 2 illustrates a perspective view of the present invention.

### DETAILED DESCRIPTION OF THE PREFERRED EMBODIMENTS

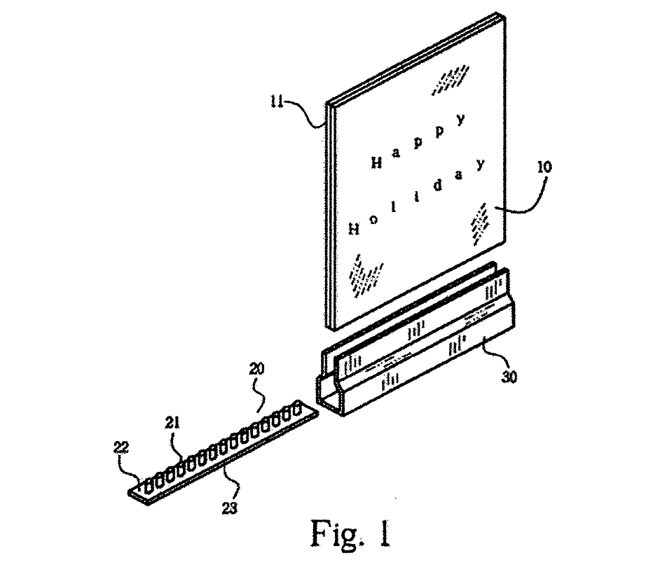

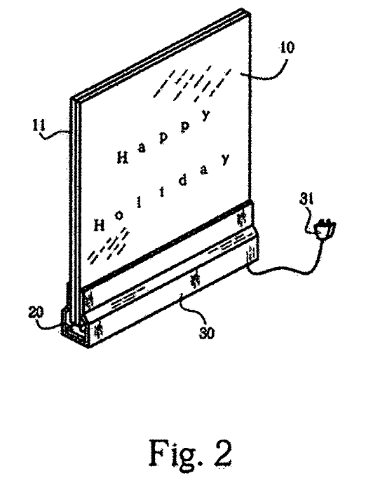

Referring to FIGS. 1-2, the transparent plate with color-changeable lighting image of the invention comprises a transparent plate 10, a color-changeable light source 20 and an attachment means 30. The transparent plate 10 is covered by a white or color image layer 11 on its surface. The color-changeable light source 20 is disposed on a side of the transparent plate 10 along a direction normal to the section of the side thereof. The transparent plate 10 and color-changeable light source 20 are fastened together by the attachment means 30. The color-changeable light source 20 comprises a plurality of colorful lamps 21, a control circuit 23, a control circuit board 22 and a power supply means 31, all of which are coupled together as follows: several sets of colorful lamps with various shape arrangements are mounted on the control circuit board 22, and control circuits 23 for controlling brightness and switching on/off of the colorful lamps 21 are disposed on the back of control circuit board 22; said sets of colorful lamps 21 include LED (light-emitting diode) lamps which can emit color light, such as red, green and blue light; the transparent plate 10 may be constructed by glass or acryl material or other transparent materials; the white or color image layer 11 may comprise kinds of patterns or words and be attached onto the surface of the transparent plate 10 by common methods such as screen-printing.

When use, the white image layer 11 may take on white image, if the lamps are not ignited; when the power supply means is switched on, under the control of the control circuits, the sets of LED lamps which are able to radiate red, green and blue light disposed linearly on the control circuit board 22 will produce flash and brightness-fadeless effect, colorful lights with different brightness emitted from the lamps will be mixed together to form the color-changeable light source 20 along with full-color alternating effect.

The light beam generated by the color-changeable light source 20 enters into the transparent plate 10 from a section of one side of the plate 10. The light mirror-reflects at both interior surfaces of the transparent plate 10 and is delivered forwardly. The light is invisible from the surfaces of the transparent plate 10, but diffuses at the white image layer 11. Since white color reflects all kinds of colors, the white image layer 11 will present color-mixing effect produced by full color alternation of the color-changeable light source 20.

The attachment means 30 is used to assemble the LED lamps, control circuit board 22 and transparent plate 10 together. The control circuit board 22 with colorful LED lamps mounted thereon is secured to the attachment means 30 by inserting itself into the attachment means 30 from one side of the attachment means 30, while the transparent plate 10 is inserted into the attachment means 30 from the top side of the attachment means 30 and then fastened thereto by fastens such as screws.

The invention may be employed in decorative lighting images or lighting indicator boards and characterized by its simple structure, low cost and beautiful decorative effect.

What is claimed is:

1. A transparent plate with color-changeable lighting image comprising: a transparent plate; an image layer covered on a surface of said transparent plate; a color-changeable light source disposed on and along a side of said transparent plate; an attachment means fastening said transparent plate on said color-changeable light source together.

2. The transparent plate with color-changeable lighting image as claimed in claim 1, wherein said color-changeable light source comprises several sets of colorful lamps with various shape arrangements, a control circuit, a control circuit board and a power supply means.

3. The transparent plate with color-changeable lighting image as claimed in claim 2, wherein said colorful lamps are LED lamps.

4. The transparent plate with color-changeable lighting image as claimed in claim 2, wherein said several sets of colorful lamps and said control circuit are disposed on said control circuit board.

5. The transparent plate with color-changeable lighting image as claimed in claim 1, wherein said image layer is a white or color image layer.

6. The transparent plate with color-changeable lighting image as claimed in claim 2, wherein said image layer is a white or color image layer.

7. The transparent plate with color-changeable lighting image as claimed in claim 5, wherein kinds of patterns or words are printed on said white or color image layer.

8. The transparent plate with color-changeable lighting image as claimed in claim 6, wherein kinds of patterns or words are printed on said white or color image layer.

9. The transparent plate with color-changeable lighting image as claimed in claim 1, wherein said transparent plate is made from glass or acryl material.

10. The transparent plate with color-changeable lighting image as claimed in claim 2, wherein the transparent plate (10) may be constructed by glass or acryl material.
